(19) United States
(12) Patent Application Publication
(10) Pub. No.: US 2022/0056179 A1
(43) Pub. Date: Feb. 24, 2022

(54) COMPOSITION COMPRISING CYANOACRYLATES AND AT LEAST ONE BLOCK COPOLYMER

(71) Applicant: Arkema France, Colombes (FR)

(72) Inventors: Sylvain Bourrigaud, LACQ (FR); Anne-Laure Brocas, LACQ (FR); Arnau Pejoan Jimenez, BELLATERRA (ES); Sylvie Cazaumayou, LACQ (FR)

(73) Assignee: Arkema France, Colombes (FR)

(21) Appl. No.: 17/413,843

(22) PCT Filed: Dec. 19, 2019
(86) PCT No.: PCT/FR2019/053184

§ 371 Date: Jun. 14, 2021

(30) Foreign Application Priority Data
Dec. 19, 2018 (FR) 1873266

(51) Int. Cl. C08F 220/34; C08F 220/18; C08F 293/00; C08F 222/32; C09J 4/06; C08F 220/06

(52) U.S. Cl. CPC C08F 220/34; C08F 220/1804; C08F 220/06; C08F 222/327; C09J 4/06; C08F 293/005

(57) ABSTRACT

The present invention relates to a composition comprising cyanoacrylate monomers and at least one block copolymer and which can be polymerized.

### CROSS-REFERENCE TO RELATED APPLICATIONS

This is the national phase of International Application No. PCT/FR2019/053184, filed 19 Dec. 2019, which claims priority to French Application No. FR 1873266, filed 19 Dec. 2018. The disclosure of each of these applications is incorporated herein by reference in its entirety for all purposes.

### FIELD OF THE INVENTION

The present invention relates to a composition comprising cyanoacrylate monomers and at least one block copolymer and which can be polymerized. This polymerized composition has mechanical properties, of heat resistance in a humid or non-humid environment, which are improved compared to known polymerized compositions. In addition, these polymerized compositions have excellent adhesive properties with respect to metals, composite materials, plastics and wood. The adhesion curing times are very short, from a few seconds to a few minutes with a long open time. Finally, these compositions have the capacity to form adhesive seals for thicknesses of up to 2 mm.

### BACKGROUND OF THE INVENTION

Cyanoacrylate compositions are known as single-component adhesive compositions with very rapid curing times which can be used on a large number of substrates except for polyolefins and fluoropolymers.

However, these adhesives exhibit brittle mechanical behavior, low peel strength, low shear strength and insufficient impact strength.

U.S. Pat. No. 5,994,464 describes a way of improving these drawbacks, by adding to the cyanoacrylate compositions core-shell particles having a soft core and a hard shell combined with an elastomer which is miscible or compatible with the formulation.

Along the same lines, EP2092017 takes up a similar concept, by adding to the cyanoacrylate compositions core-shell particles having a soft core and a hard shell combined with an elastomer.

The applicant shows in the present invention that the formulations of cyanoacrylate monomers combined with at least one block copolymer makes it possible to dispense with the presence of core-shell particles while exhibiting adhesive properties and mechanical properties, of heat resistance in a humid or non-humid environment, which are improved with respect to known compositions, while dispensing with the presence of core-shell particles, making these compositions formulations that are simpler to prepare. Moreover, the applicant has shown that the production of block copolymers comprising at least one cyanoacrylate monomer is made possible by nitroxide-mediated radical polymerization, contrary to what the prior art asserts (C. Duffy et al. Journal of Polymer Science, Part A: Polymer Chemistry 2017, 55, 1397-1408).

### SUMMARY OF THE INVENTION

The invention relates to a composition comprising at least one cyanoacrylate monomer (1) and at least one block copolymer containing no diene monomer, this composition not comprising core-shell particles.

### DETAILED DESCRIPTION OF THE INVENTION

The compositions of the invention comprise a cyanoacrylate monomer (1) and at least one block copolymer containing no diene monomer, it being possible for this block copolymer to optionally contain a cyanoacrylate monomer (2), this composition not comprising core-shell particles.

The monomers (1) and (2) can be wholly or partly different or equivalent.

The term “cyanoacrylate monomer (1)” is intended to mean any type of cyanoacrylate monomer, but in particular the following monomers represented by formula A:

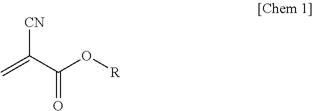

wherein R is chosen from linear or branched C₁ to C₁₆ alkyl, C₂ to C₁₆ alkoxyalkyl, C₃ to C₁₆ cycloalkyl, C₂ to C₁₆ alkenyl, C₁ to C₁₆ aralkyl, C₆ to C₁₆ aryl, C₃ to C₁₆ allyl and C₁ to C₁₆ haloalkyl groups and more particularly 2-methyl cyanoacrylate, ethyl cyanoacrylate, butyl cyanoacrylate, propyl cyanoacrylate and octyl cyanoacrylate, 2-methoxyethyl cyanoacrylate and preferably 2-methoxyethyl cyanoacrylate.

The term “block copolymer” is intended to mean any type of block copolymer and preferably diblock copolymers or triblock copolymers and more preferably diblock copolymers. These block copolymers contain no diene monomers. This is because copolymers containing diene monomers, for example SBS or SEBS, have low solubility in cyanoacrylate monomers and are not suitable for the compositions of the invention.

The presence of acid is known to be necessary for the polymerization of cyanoacrylates. The acid makes it possible to polymerize cyanoacrylates by the radical route. The conventional cyanoacrylate polymerization process is anionic. To avoid this mechanism, it is known to add acid.

While in the present invention the presence of acid can be provided by a monomer during the production of the block copolymer and therefore forms an integral part of the block copolymer, the presence of acid can also be provided by a non-polymerizable acid, that is to say one not bearing double bonds. The amount of acid is between 0.1 and 5 mol % of the cyanoacrylate monomers present within the block containing the cyanoacrylate monomer(s) and preferably between 0.6 and 2.5% in order to carry out the polymerization via a radical mechanism with reasonable kinetics, that is to say of a few hours.

According to one preference, the block copolymers have in at least one of the blocks at least one monomer having acid functions and one cyanoacrylate monomer (2), in particular the following monomers represented by formula A:

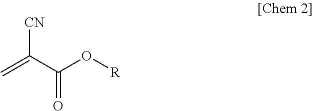

wherein R is chosen from linear or branched C₁ to C₁₆ alkyl, C₂ to C₁₆ alkoxyalkyl, C₃ to C₁₆ cycloalkyl, C₂ to C₁₆ alkenyl, C₁ to C₁₆ aralkyl, C₆ to C₁₆ aryl, C₃ to C₁₆ allyl and C₁ to C₁₆ haloalkyl groups and more particularly 2-methyl cyanoacrylate, ethyl cyanoacrylate, butyl cyanoacrylate, propyl cyanoacrylate and octyl cyanoacrylate, 2-methoxyethyl cyanoacrylate and preferably 2-methoxyethyl cyanoacrylate.

The acid monomers are chosen from acrylic acid, methacrylic acid and itaconic acid in molar proportions relative to the cyanoacrylate monomer of between 0.1 and 5% and preferably between 0.6 and 2.5%.

According to a second preference, the presence of acid is ensured by a non-polymerizable acid such as organic acids, for example trichloroacetic acid, trifluoroacetic acid, sulfonic acids in particular methanesulfonic acid, para-toluenesulfonic acid, preferably methanesulfonic acid, in molar proportions relative to the cyanoacrylate monomer of between 0.1 and 5% and preferably between 0.6 and 2.5%. In this case, the block copolymers comprising at least one cyanoacrylate monomer do not bear an acid function.

The compositions of the invention do not contain core-shell particles or block copolymers containing diene monomers.

According to another preference of the invention, the cyanoacrylate monomers present in the composition of the invention are partly or completely identical to those present in the one or more, or even all of the, block copolymers within one or more blocks of the block copolymers present in the composition of the invention.

The production of the block copolymers present in the compositions of the invention is carried out in a controlled radical manner.

The term “controlled radical polymerization” can mean controlled by any known technique, such as NMP (“Nitroxide Mediated Polymerization”), RAFT (“Reversible Addition and Fragmentation Transfer”), ATRP (“Atom Transfer Radical Polymerization”), INIFERTER (“Initiator-Transfer-Termination”), RITP (“Reverse Iodine Transfer Polymerization”), ITP (“Iodine Transfer Polymerization).

According to one preferred form of the invention, the copolymers are produced by nitroxide-mediated polymerization (NMP).

More particularly, the nitroxides resulting from the alkoxyamines derived from the stable free radical (3) are preferred.

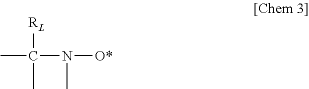

wherein the radical R_{L} has a molar mass of greater than 15.0342 g/mol. The radical R_{L} can be a halogen atom, such as chlorine, bromine or iodine, a saturated or unsaturated and linear, branched or cyclic hydrocarbon group, such as an alkyl or phenyl radical, or an ester COOR group or an alkoxyl OR group or a phosphonate PO(OR)₂ group, provided that it exhibits a molar mass of greater than 15.0342. The radical R_{L}, which is monovalent, is said to be in the * position with respect to the nitrogen atom of the nitroxide radical. The remaining valencies of the carbon atom and of the nitrogen atom in the formula (3) can be bonded to various radicals, such as a hydrogen atom or a hydrocarbon radical, such as an alkyl, aryl or arylalkyl radical, comprising from 1 to 10 carbon atoms. It is not excluded for the carbon atom and the nitrogen atom in the formula (3) to be connected together via a divalent radical, so as to form a ring. Preferably, however, the remaining valencies of the carbon atom and of the nitrogen atom of the formula (3) are bonded to monovalent radicals. Preferably, the radical R_{L} exhibits a molar mass of greater than 30 g/mol. The radical R_{L} can, for example, have a molar mass of between 40 and 450 g/mol. By way of example, the radical R_{L} can be a radical comprising a phosphoryl group, it being possible for said radical R_{L} to be represented by the formula:

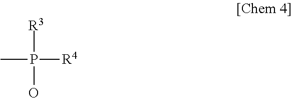

wherein R³ and R⁴, which may be identical or different, can be chosen from alkyl, cycloalkyl, alkoxyl, aryloxyl, aryl, aralkyloxyl, perfluoroalkyl or aralkyl radicals and can comprise from 1 to 20 carbon atoms. R³ and/or R⁴ can also be a halogen atom, such as a chlorine or bromine or fluorine or iodine atom. The radical R_{L} can also comprise at least one aromatic ring, such as for the phenyl radical or the naphthyl radical, it being possible for said ring to be substituted, for example by an alkyl radical comprising from 1 to 4 carbon atoms.

More particularly, the alkoxyamines derived from the following stable radicals are preferred:
N-(tert-butyl)-1-phenyl-2-methylpropyl nitroxide,
N-(tert-butyl)-1-(2-naphthyl)-2-methylpropyl nitroxide,
N-(tert-butyl)-1-diethylphosphono-2,2-dimethylpropyl nitroxide,
N-(tert-butyl)-1-dibenzylphosphono-2,2-dimethylpropyl nitroxide,
N-phenyl-1-diethylphosphono-2,2-dimethylpropyl nitroxide,
N-phenyl-1-diethylphosphono-1-methylethyl nitroxide,
N-(1-phenyl-2-methylpropyl)-1-diethylphosphono-1-methylethyl nitroxide,
4-oxo-2,2,6,6-tetramethyl-1-piperidinyloxy,
2,4,6-tri(tert-butyl)phenoxy nitroxide,
N-(tert-butyl)-1-diethylphosphono-2,2-dimethylpropyl nitroxide.

The alkoxyamines used in controlled radical polymerization must allow good control of the linking of the monomers. Thus, they do not all allow good control of certain monomers. For example, the alkoxyamines derived from TEMPO make it possible to control only a limited number of monomers; the same is true for the alkoxyamines derived from 2,2,5-trimethyl-4-phenyl-3-azahexane-3-nitroxide (TIPNO). On the other hand, other alkoxyamines derived from nitroxides corresponding to formula (3), particularly those derived from nitroxides corresponding to formula (4) and even more particularly those derived from N-(tert-butyl)-1-diethylphosphono-2,2-dimethylpropyl nitroxide, make it possible to broaden the controlled radical polymerization of these monomers to a large number of monomers.

In addition, the opening temperature of the alkoxyamines also influences the economic factor. The use of low temperatures will be preferred in order to minimize the industrial difficulties. The alkoxyamines derived from nitroxides corresponding to formula (3), particularly those derived from nitroxides corresponding to formula (4) and even more particularly those derived from N-(tert-butyl)-1-diethylphosphono-2,2-dimethylpropyl nitroxide, will therefore be preferred to those derived from TEMPO or 2,2,5-trimethyl-4-phenyl-3-azahexane-3-nitroxide (TIPNO).

According to one preferred form of the invention, the block copolymers are prepared by controlled radical polymerization, even more particularly by nitroxide-mediated polymerization, the nitroxide being in particular N-(tert-butyl)-1-diethylphosphono-2,2-dimethylpropyl nitroxide.

The monomers other than the cyanoacrylate monomers that may be present within the block copolymers present within the compositions of the invention will be chosen from the following: vinyl, vinylidene, olefinic, allyl or (meth)acrylic monomers, more particularly from vinylaromatic monomers such as styrene or substituted styrenes, especially alpha-methylstyrene, monofluoro, difluoro, trifluoro, tetrafluoro or pentafluro styrenes, acrylic monomers such as acrylic acid or salts thereof, alkyl, cycloalkyl or aryl acrylates such as methyl, ethyl, butyl, ethylhexyl or phenyl acrylate, hydroxyalkyl acrylates such as 2-hydroxyethyl acrylate, ether alkyl acrylates such as 2-methoxyethyl acrylate, alkoxy- or aryloxypolyalkylene glycol acrylates such as methoxypolyethylene glycol acrylates, ethoxypolyethylene glycol acrylates, methoxypolypropylene glycol acrylates, methoxypolyethylene glycol-polypropylene glycol acrylates, or mixtures thereof, aminoalkyl acrylates such as 2-(dimethylamino)ethyl acrylate (DMAEA), fluoroacrylates, silylated acrylates, phosphorus-comprising acrylates such as alkylene glycol phosphate acrylates, glycidyl or dicyclopentenyloxyethyl acrylates, methacrylic monomers such as methacrylic acid or salts thereof, alkyl, cycloalkyl, alkenyl or aryl methacrylates such as methyl methacrylate (MMA), lauryl, cyclohexyl, allyl, phenyl or naphthyl methacrylate, hydroxyalkyl methacrylates such as 2-hydroxyethyl methacrylate or 2-hydroxypropyl methacrylate, ether alkyl methacrylates such as 2-ethoxyethyl methacrylate, alkoxy- or aryloxypolyalkylene glycol methacrylates such as methoxypolyethylene glycol methacrylates, ethoxypolyethylene glycol methacrylates, methoxypolypropylene glycol methacrylates, methoxypolyethylene glycol-polypropylene glycol methacrylates, or mixtures thereof, aminoalkyl methacrylates such as 2-(dimethylamino)ethyl methacrylate (DMAEMA), fluoromethacrylates such as 2,2,2-trifluoroethyl methacrylate, silylated methacrylates such as 3-methacryloylpropyltrimethylsilane, phosphorus-comprising methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethylammonium chloride (MAPTAC), glycidyl or dicyclopentenyloxyethyl methacrylates, itaconic acid, maleic acid or salts thereof, maleic anhydride, alkyl or alkoxy- or aryloxypolyalkylene glycol maleates or hemimaleates, vinylpyridine, vinylpyrrolidinone, (alkoxy)poly(alkylene glycol) vinyl ether or divinyl ether, such as methoxypoly(ethylene glycol) vinyl ether, poly(ethylene glycol) divinyl ether, olefinic monomers, among which mention may be made of ethylene, butene, hexene and 1-octene, and also fluoroolefinic monomers, and vinylidene monomers, among which mention may be made of vinylidene fluoride, all these monomers taken alone or as a mixture of at least two abovementioned monomers.

The block copolymers present within the composition of the invention have a Tg of less than −10° C. and a Tg of greater than 25° C., measured by DSC.

Preferably, the monomers other than the cyanoacrylate monomers are chosen from C₁ to C₈ and preferably C₁ to C₄ alkyl acrylates or methacrylates, and also styrene and substituted styrenes. More preferably, the monomers other than the cyanoacrylate monomers are chosen from methyl methacrylate, butyl acrylate, 2-ethylhexyl acrylate and styrene. The cyanoacrylate monomer(s) are present in the block having a Tg of less than −10° C. or in the block having a Tg of greater than 25° C. Even more preferably, the cyanoacrylate monomer(s) are present within a block having a Tg of less than −10° C.

At least one of the block copolymers present in the composition of the invention has a number-average molecular weight, measured by SEC (polystyrene standards), of between 10 000 and 100 000 and preferably between 15 000 and 50 000.

At least one of the block copolymers included in the composition of the invention has a block of Tg<−10° C./block of Tg>25° C. ratio by weight of between 5/95 and 95/5, preferably between 30/70 and 70/30, and preferably between 45/55 and 55/45.

The ratio by weight of cyanoacrylate monomers (2) to block copolymer is between 1/99 and 80/20, preferably between 1/99 and 50/50 and more preferably between 1/99 and 30/70.

As regards the process allowing the production of the block copolymer(s) present within the compositions of the invention, it is a solvent process, excluding a bulk process or a process in the presence of water (emulsion, suspension). The applicant has thus shown that above 70% by weight in terms of solids content, the polymerization leads to a product which cannot be recovered because it is in the form of a gel or in another form such as a product that has set solid. The invention therefore also relates to the process for obtaining the block copolymers of the compositions of the invention when a cyanoacrylate monomer is present in at least one of the blocks, said process being a solvent phase process with a solids content of less than or equal to 70% by weight, preferably less than 50% and more preferably less than 40%, comprising the following steps:
introduction, into a reactor, of the monomers of a first block of the block copolymer in the presence of polymerizable or non-polymerizable acid, with a nitroxide-mediated radical polymerization initiator-controller in a solvent with a solids content less than or equal to 70% by weight;
polymerization of the first block and evaporation of the monomers which have not reacted during this step;
introduction of the monomers of the second block (optionally of the third block if the initiator-controller is bifunctional);
polymerization of the second block (optionally of the third block) and evaporation of the monomers which have not reacted during this step;
recovery of the block copolymer by evaporation of the residual solvent.

In this polymerization process, the maximum solids content is 70% when the acid is a non-polymerizable organic acid, preferably methanesulfonic acid, and 40% when the acid is a polymerizable acid monomer.

These solids contents may differ depending on the type of cyanoacrylate monomer considered and/or the amount of acid used. The solvent can be of any type, provided that it solubilizes the constituent monomers of the block copolymer and also the block copolymer. Preferably the solvent is toluene.

The invention also relates to the block copolymer(s) present in the compositions of the invention, when these block copolymers comprise a cyanoacrylate monomer.

The compositions of the invention may contain one or more polymerization accelerators, such as crown ethers, calixarenes, amines, disulfides, fillers, stabilizers, thickeners or other additives.

The invention also relates to the use of the compositions as an adhesive.

### EXAMPLES

### Example 1

Synthesis of a living poly(butyl acrylate-co-cyanoacrylate) copolymer, hereafter PBA-PCA 90/10 (% by weight) (macroinitiator).

The following are introduced into a 2 I reactor purged with nitrogen:
324 g Butyl acrylate 2.53 mol
36 g Methoxyethyl cyanoacrylate 0.23 mol
534 g Toluene 10 ppm H₂O
36 g Methacrylic acid 0.0015 mol
5.66 g BlocBuider® MA (Arkema) 0.015 mol (initiator-controller).

The monomers are introduced into a stainless steel reactor by vacuum.

The reaction mixture is stirred and degassed (vacuum/nitrogen 3 times).

The reaction mixture is heated to a temperature of 115° C.

The temperature is maintained at 115° C. throughout the polymerization until a degree of monomer conversion of 70% is reached. Samples are taken at regular intervals in order to determine the polymerization kinetics by gravimetric analysis (measurement of dry extract).

When the desired conversion is achieved, the reaction medium is cooled.

The residual monomers are evaporated off under vacuum.

The procedure is carried out in the same way with the other cyanoacrylate monomers: table 1.

TABLE 1

| | | | % (by | % (by | | |
|---|---|---|---|---|---|---|
| | | % Solids | mole) | mole) | | |
| | | content | MAA | MSA | | |
| | Cyano- | by | relative | relative | Poly- | Mn |
| | acrylate | weight | to CA | to CA | merization | g/mol |
| Test 1 | MECA | 40 | 0.65 | 0 | yes | 11 000 |
| Test 2 | MECA | 40 | 4 | 0 | Setting to | |
| | | | | | solid | |
| Test 3 | MECA | 40 | 0 | 0.65 | yes | 11 500 |
| Test 4 | MECA | 40 | 0 | 4 | no | |
| Test 5 | MECA | 55 | 0.65 | 0 | Setting to | |
| | | | | | solid | |
| Test 6 | MECA | 55 | 26 | 0 | Setting to | |
| | | | | | solid | |
| Test 7 | MECA | 70 | 0 | 1 | yes | 11 000 |
| Test 8 | ECA | 40 | 2.2 | 0 | yes | 12 000 |
| Test 9 | BuCA | 40 | 2.2 | 0 | yes | 12 00 |

Cyanoacrylate: Methoxyethyl cyanoacrylate (MECA);
Ethyl cyanoacrylate (ECA),
Butyl cyanoacrylate (BuCA).
MAA: Methacrylic acid;
MSA: Methanesulfonic acid.

### Example 2

### Synthesis of Block Copolymer (PBA-PCA)-b-PMMA

294 g of toluene and also 180 g of methyl methacrylate and 125.5 g of the macroinitiator synthesized in example 1 (PBA-PMECA or PBA-PBuCA) are introduced into a stainless steel reactor equipped with a mechanical stirrer and a jacket.

The reaction mixture is introduced into the reactor by vacuum, stirred and degassed by vacuum/nitrogen.

The temperature of the reaction medium is then brought to 115° C. The temperature is kept constant throughout the polymerization until a degree of monomer conversion of 70% is reached. Samples are taken at regular intervals in order to determine the polymerization kinetics by gravimetric analysis (measurement of dry extract).

The residuals of the monomers and also the solvent are evaporated off under vacuum: table 2.

Synthesis of Block copolymers: (PBA-PCA)-b-PMMA 50/50 (% by weight):

TABLE 2

| 1st block PBA-PCA 90/10 | Mn g/mol Copolymer |
|---|---|
| (% by weight) | (PBA-PCA)-b-(PMMA) |
| PBA-PMECA (test 1) | 20 000 |
| PBA-PECA (test 6) | 21 000 |
| PBA-PBuCA (test 7) | 22 000 |

1. A composition comprising at least one cyanoacrylate monomer (1) and at least one block copolymer having at least one cyanoacrylate monomer (2), optionally an acid monomer, containing no diene monomer, this composition not comprising core-shell particles.

2. The composition as claimed in claim 1, wherein the cyanoacrylate monomers (1) and (2) are represented by formula A: 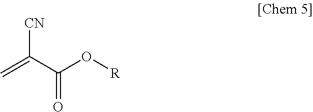
wherein R is chosen from linear or branched C₁ to C₁₆ alkyl, C₂ to C₁₆ alkoxyalkyl, C₃ to C₁₆ cycloalkyl, C₂ to C₁₆ alkenyl, C₁ to C₁₆ aralkyl, C₆ to C₁₆ aryl, C₃ to C₁₆ allyl and C₁ to C₁₆ haloalkyl groups.

3. The composition as claimed in claim 1, wherein (1) and (2) are chosen from methyl cyanoacrylate, ethyl cyanoacrylate, propyl cyanoacrylate, octyl cyanoacrylate, butyl cyanoacrylate and 2-methoxyethyl cyanoacrylate.

4. The composition as claimed in claim 1, wherein the cyanoacrylate monomers (1) and (2) are identical.

5. The composition as claimed in claim 1, wherein the cyanoacrylate monomers (1) and (2) are 2-methoxyethyl cyanoacrylate, ethyl cyanoacrylate or butyl cyanoacrylate.

6. The composition as claimed in claim 1, wherein the monomers bearing an acid function when they are present are chosen from acrylic acid, methacrylic acid and itaconic acid, in molar proportions of between 0.1 and 5%, limits included, relative to the number of moles of monomers of the block(s) containing the cyanoacrylate monomer(s).

7. The composition as claimed in claim 1, wherein, when the acid monomers are not present, the acid functions are provided by a non-polymerizable acid, in molar proportions of between 0.1 and 5%, limits included, relative to the number of moles of monomers of the block(s) containing the cyanoacrylate monomer(s).

8. The composition as claimed in claim 1, wherein at least one block copolymer has a Tg measured by DSC of less than −10° C. and a Tg measured by DSC of greater than 25° C.

9. The composition as claimed in claim 1, wherein at least one block copolymer comprises monomers chosen from butyl acrylate, 2-ethylhexyl acrylate, methyl methacrylate or styrene.

10. The composition as claimed in claim 8, wherein at least one block copolymer has a number-average molecular weight measured by SEC of between 10 000 and 100 000 g/mol.

11. The composition as claimed in claim 1, wherein the ratio by weight of cyanoacrylate monomers (1) to block copolymer is between 5/95 and 95/5.

12. The composition as claimed in claim 8, wherein at least one block copolymer has a Tg block<−10° C./Tg block>25° C. ratio of between 5/95 and 95/5.

13. The composition as claimed in claim 1, comprising an accelerator such as crown ethers, calixarenes, amines, disulfides, fillers, stabilizers, thickeners or other additives.

14. The composition as claimed in claim 1, wherein at least one block copolymer is prepared by controlled radical polymerization.

15. The composition as claimed in claim 14, wherein at least one block copolymer is prepared by nitroxide-mediated radical polymerization.

16. The composition as claimed in claim 15, wherein the nitroxide is N-(tert-butyl)-1-diethylphosphono-2,2-dimethylpropyl nitroxide.

17. A process for the synthesis of at least one block copolymer in at least one of the blocks as claimed in claim 14, comprising the following steps:
introduction, into a reactor, of the monomers of a first block of the block copolymer with a nitroxide-mediated radical polymerization initiator-controller in a solvent with a solids content less than or equal to 70% by weight;
polymerization of the first block and evaporation of the monomers which have not reacted during this step;
introduction of the monomers of the second block (optionally of the third block if the initiator-controller is bifunctional);
polymerization of the second block (optionally of the third block) and evaporation of the monomers which have not reacted during this step;
recovery of the block copolymer by evaporation of the residual solvent.

18. A block copolymer obtained by means of the process of claim 17.

19. An adhesive comprising a composition as claimed in claim 1.
